(19) United States
(12) Patent Application Publication
(10) Pub. No.: US 2026/0291047 A1
(43) Pub. Date: Sep. 24, 2026

(54) VEHICLE GLASS AND MANUFACTURING METHOD THEREFOR, AND INTELLIGENT CONNECTED VEHICLE

(71) Applicant: FUYAO GLASS INDUSTRY GROUP CO., LTD., Fuqing City (CN)

(72) Inventor: Xiaqun Yu, Fuqing City, Fujian Province (CN)

(21) Appl. No.: 18/868,587

(22) PCT Filed: Jun. 7, 2023
(86) PCT No.: PCT/CN2023/098751

§ 371 Date: Nov. 22, 2024

(30) Foreign Application Priority Data
Jun. 7, 2022 (CN) 202210634994.7

(51) Int. Cl. H01Q 1/12; B60R 11/00; H01Q 1/32

(52) U.S. Cl. CPC H01Q 1/1271; H01Q 1/325; B60R 2011/0026

(57) ABSTRACT

The present disclosure provides vehicle glass, a manufacturing method therefor and an intelligent connected vehicle. The vehicle glass includes a glass, an adhesive layer and an antenna module, the antenna module is bonded to the glass by means of the adhesive layer, or the vehicle glass further includes a bracket, the bracket is bonded to the glass by the adhesive layer and the antenna module is clamped on the bracket, in which, the adhesive layer is distributed, in form of short lines, on an edge area of a bottom surface of the antenna module or a bottom surface of the bracket.

The present application claims priority to Chinese Patent Application No. 202210634994.7, entitled “Vehicle-Mounted Glass and Manufacturing Method Therefor and Intelligent Connected Vehicle” and filed with the Chinese Patent Office on Jun. 7, 2022, which is hereby incorporated by reference in its entirety.

### TECHNICAL FIELD

The present disclosure relates to a vehicle glass and a manufacturing method therefor, and an intelligent connected vehicle, relating to the technical field of intelligent vehicles and components and parts thereof.

### BACKGROUND

With the development of new intelligent connected vehicles, their pursuit of optimal appearance and the large-scale application of single-piece glass has increasingly limited the space available outside the vehicle for installing vehicle antennas that support functions such as vehicle charging, communication, and positioning. According to the planning of the existing complete-machine manufacturers, the antennas realizing the above-mentioned functions all have begun to be transferred inside the vehicle. Directly fixing an antenna to the glass where it is located is a solution to allow the antenna to work under normal conditions. This solution usually adopts a mounting bracket, which is used as a bridge between the antenna and the glass, that is, first the bracket is fixed to the glass by means of an adhesive, and then the antenna is clamped on the bracket. In addition, the antenna may also be directly bonded to the glass.

Currently, with regard to the way of bonding the antenna to the glass by means of an adhesive, due to the lack of consideration of the material characteristics of the adhesive or the insufficient study of its characteristics, the performance of the antenna would be greatly affected no matter whether the antenna is fixed by using a bracket as a bridge or the antenna is directly fixed to the glass by bonding. Research has found that improper use of adhesive can reduce the Gain of the antenna by 0.5 dB-1.5 dB, or even more.

Therefore, providing a new vehicle-mounted glass and a manufacturing method therefor and an intelligent connected vehicle has become a technical problem that needs to be solved urgently in this field.

### SUMMARY

To address the mentioned disadvantage and deficiency, an objective of the present disclosure is to provide a vehicle glass.

Another objective of the present disclosure is to provide a manufacturing method of the vehicle glass.

A further objective of the present disclosure is to provide an intelligent connected vehicle, which at least comprises the vehicle glass.

To achieve these objectives, in one aspect, the present disclosure provides vehicle glass, which comprises glass, an adhesive layer and an antenna module; the antenna module is bonded to the glass by the adhesive layer, or the vehicle-mounted glass further comprises a bracket, the bracket is bonded to the glass by the adhesive layer, and the antenna module is clamped on the bracket, in which, the adhesive layer is distributed, in form of short lines, on an edge area of a bottom surface of the antenna module or an edge area of a bottom surface of the bracket.

In the present disclosure, the bottom surface is a surface of the antenna module or of the bracket that is to be bonded to the glass.

In a specific embodiment of the vehicle glass of the present disclosure, the short lines include line segments or short arcs.

In the present disclosure, the form of the short lines may be determined based on the shape of the bottom surface, for example: when the bottom surface is circular or oval, the short lines may be distributed in the form of short arcs on the edge area of the bottom surface of the antenna module or the edge area of the bottom surface of the bracket; and when the bottom surface is square or rectangular, the short lines may be distributed in the form of line segments on the edge area of the bottom surface of the antenna module or the edge area of the bottom surface of the bracket.

In a specific embodiment of the vehicle glass of the present disclosure, the adhesive layer is distributed on a periphery of the bottom surface of the antenna module or a periphery of the bottom surface of the bracket.

In a specific embodiment of the vehicle glass of the present disclosure, the adhesive layer includes four adhesive blocks in the form of a line segment, which are distribute on the edge areas of all edges of the bottom surface.

In a specific embodiment of the vehicle glass of the present disclosure, a length of the adhesive block is smaller than a side length of the bottom surface.

In a specific embodiment of the vehicle glass of the present disclosure, a length of the adhesive block is less than or equal to 40% of the edge length and greater than or equal to 30% of the edge length, and a width of the adhesive block is not greater than 15 mm (based on a maximum outer diameter of the antenna module aperture surface or a maximum outer diameter of the edge of the bracket).

In the present disclosure, the four adhesive blocks may have exactly the same length, and may also have different lengths; exemplarily, the four adhesive blocks have exactly the same length.

In a specific embodiment of the vehicle glass of the present disclosure, the adhesive layer includes four adhesive blocks each in form of a right-angled broken line structure, which are distributed on the edge areas of the four corners of the bottom surface, and any two adjacent adhesive blocks are not completely connected.

In a specific embodiment of the vehicle-mounted glass of the present disclosure, a total length of the four adhesive blocks in the form of a right-angled broken line structure is not less than 30% of a total perimeter of the bottom surface, and not greater than 40% of the total perimeter of the bottom surface, and a width thereof is not greater than 15 mm.

In the present disclosure, the lengths of the two line segments in any one of the four adhesive blocks in the form of a right-angled broken line structure may be exactly the same, and may also be different; optionally, the lengths of the two line segments in any one of the adhesive blocks are exactly the same;

the lengths of the line segments of the four adhesive blocks each in the form of a right-angled broken line structure may be exactly the same, and may also be different; optionally, the lengths of the line segments of the four adhesive blocks are exactly the same.

In a specific embodiment of the vehicle glass of the present disclosure, the adhesive layer includes four adhesive blocks each in form of a 90° round-corner broken line structure, and the four adhesive blocks are distributed on the edge areas of the four corners of the bottom surface, respectively.

In a specific embodiment of the vehicle glass of the present disclosure, a total length of the four adhesive blocks in the form of a 90° round-corner broken line structure is not less than 30% of a total perimeter of the bottom surface, and not greater than 40% of the total perimeter of the bottom surface, and a width thereof is not greater than 15 mm.

In the present disclosure, the lengths of the two line segments in any one of the four adhesive blocks in the form of a 90° round-corner broken line structure may be exactly the same, and may also be different; optionally, the lengths of the two line segments in any one of the adhesive blocks are exactly the same;
the lengths of the line segments of the four adhesive blocks each in the form of a 90° round-corner broken line structure may be exactly the same, and may also be different; optionally, the lengths of the line segments of the four adhesive blocks are exactly the same.

In a specific embodiment of the vehicle glass according to the present disclosure, an adhesive for forming the adhesive layer includes one or more of polyurethane, acrylic resin, polycarbonate resin, ABS (acrylonitrile-butadiene-styrene) resin and fluororesin.

In the present disclosure, the glass and the antenna module are both conventional devices that can be reasonably selected based on actual need.

In another aspect, the present disclosure also provides a manufacturing method of the vehicle glass, in which, the method includes:
applying an adhesive to an edge area of a bottom surface of an antenna module or an edge area of a bottom surface of a bracket by spot coating;
bonding the bottom surface of the antenna module to the glass to obtain the vehicle glass; or bonding the bottom surface of the bracket to the glass and then clamping the antenna module on the bracket to obtain the vehicle glass.

In a specific embodiment of the method of the present disclosure, the spot coating is multi-point spot coating.

In some embodiments of the present disclosure, the spot coating is four-point spot coating.

In the present disclosure, the “multi-point spot coating” is defined relative to “full adhesive coating” known to the inventor, and the “multi-point spot coating” refers to the application of a target adhesive to a carrier surface in a way different from “full adhesive coating”, such as in short lines as described above, with a suitable tool, so that the applied adhesive layer only partially covers the carrier surface.

In a further aspect, the present disclosure provides an intelligent connected vehicle, in which, the intelligent connected vehicle at least includes the above-mentioned vehicle glass.

Compared with the way to obtain vehicle glass by bonding the antenna module to the glass by full adhesive coating known to the inventor, the present disclosure changes the way to coat adhesive, that is, the present disclosure adopts the way of four-point spot coating to bond the antenna module or the bracket to the glass, and within a certain frequency range, the Gain of the antenna module in the vehicle glass obtained by the present disclosure is significantly increased. To be specific, in some specific embodiments of the present disclosure, in the frequency range of 1160 MHz-1610 MHz, the Gain of the antenna module in the vehicle glass obtained by the present disclosure can be increased by about 1.5 dB at most.

### BRIEF DESCRIPTION OF THE DRAWINGS

For a clearer illustration of technical features in the embodiments of the present disclosure or the prior art, a brief description of the drawings for the embodiments or the prior art will be given below. It should be understood that the drawings described below are only some embodiments of the present disclosure. For an ordinary person skilled in the art, other drawings can be derived from these drawings without any inventive efforts.

FIG. 1 is a schematic diagram of an adhesive layer structure formed by four-point spot coating according to a first embodiment of the present disclosure;

FIG. 2 is a simulated schematic diagram of the adhesive layer structure formed by four-point spot coating according to the first embodiment of the present disclosure;

FIG. 3 is a simulated schematic diagram of an adhesive layer structure formed by four-point spot coating according to a second embodiment of the present disclosure;

FIG. 4 is a schematic diagram of an adhesive layer structure formed by full adhesive coating in a first comparative example;

FIG. 5 is a schematic diagram of integral installation of a vehicle-mounted glass according to a first embodiment of the present disclosure;

FIG. 6 is a sectional view along line A-A in FIG. 5;

FIGS. 7 and 8 illustrate Gain performance curves of antenna modules in the vehicle-mounted glasses according to the first embodiment of the present disclosure and the first comparative example within the frequency range of 1160 MHz-1610 MHz.

### DESCRIPTION OF THE MAIN REFERENCE SIGNS

1. Antenna module;
2. Glass;
3. Adhesive layer.

### DETAILED DESCRIPTION OF THE EMBODIMENTS

It should be noted that the terms “comprise/include” and any variations thereof used in the Description and claims of the present disclosure and the above-mentioned figures are intended to cover non-exclusive inclusions. For example, processes, methods, systems, products or devices comprising a series of steps or units are not necessarily limited to those steps or units clearly listed, but may comprise other steps or units that are not clearly listed or inherent to such processes, methods, products or devices.

In the present disclosure, the terms “upper”, “lower”, “inner”, “outer”, “middle” and the like indicate an orientation or position relationship based on the orientation or position relationship shown in the figures. These terms are intended primarily to better describe the present disclosure and its examples, and are not intended to define that the devices, elements, or components indicated must have a specific orientation or be constructed and operated in a specific orientation.

In addition, some of the above terms may be used to indicate other meanings in addition to an orientation or position relationship, for example, the term “upper” may also be used to indicate a certain dependency or connection relationship in some cases. An ordinary person skilled in the art can understand the specific meaning of the terms in the present disclosure according to actual situations.

In order to make the objectives, technical solutions and advantages of the present disclosure more distinct, further detailed description of the present disclosure will be given in the following in combination with the figures and the examples. The examples described below are some examples rather than all the examples of the present disclosure, and are used only to illustrate the present disclosure, and should not be regarded as limiting the scope of the present disclosure. Based on the examples of the present disclosure, all other examples obtained by an ordinary person skilled in the art without paying creative effort should fall within the scope of protection of the present disclosure. Where specific conditions are not specified in the examples, the conventional conditions or the conditions recommended by the manufacturers are followed. Where manufacturers of the reagents or instruments used are not specified, they are all commercially available conventional products.

### The First Embodiment

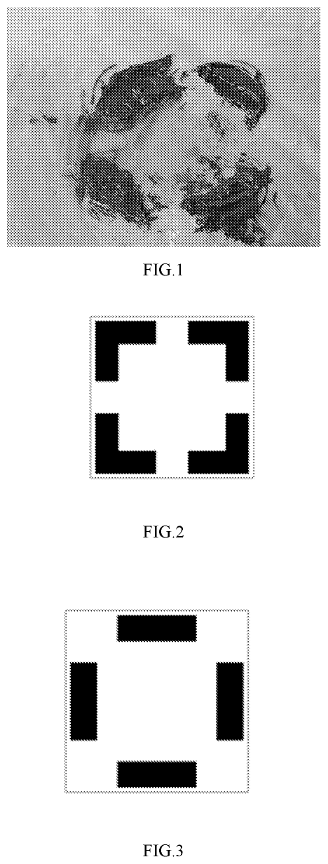

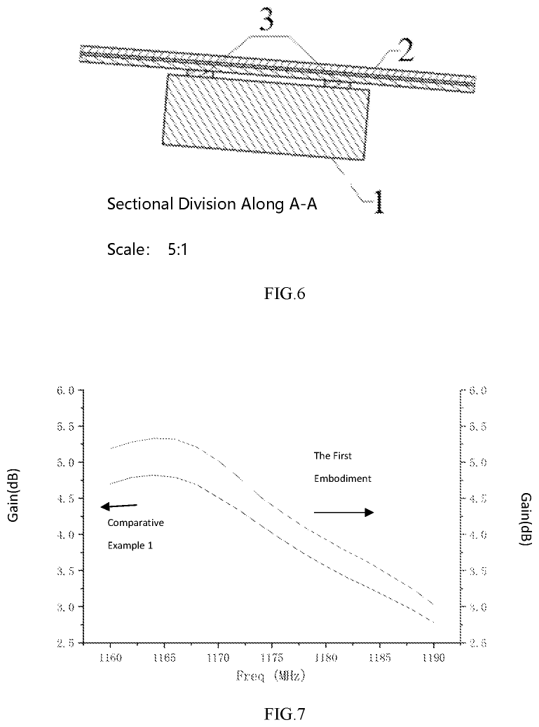

This embodiment provides a manufacturing method for a vehicle glass, including the following specific steps:
(1) applying a polyurethane adhesive to an edge area of each of four corners of a bottom surface of an antenna module to be bonded to glass by four-point spot coating, to form four adhesive blocks each in form of a right-angled broken line structure in the edge areas of the four corners of the bottom surface, as shown in FIG. 1 and FIG. 2;
in this step, the antenna module has a weight of about 0.7 kg and a size of about 70×70 mm, and requires a tensile force of greater than 200 N, a width of each of the adhesive applied in step (1) is less than 8 mm, and a length of the right-angled broken line structure is less than 25 mm;
(2) bonding the bottom surface of the antenna module to the glass by an adhesive layer formed by the adhesive to obtain the vehicle glass; in this step, the installation diagram of the vehicle glass is shown in FIG. 5 and FIG. 6, from which it can be seen that the vehicle glass includes the glass 2, the adhesive layer 3 and the antenna module 1, the antenna module 1 is bonded to the glass 2 by the adhesive layer 3, the adhesive layer 3 includes four adhesive blocks each in the form of a right-angled broken line structure, and the four adhesive blocks are distributed on the edge areas of the four corners of the bottom surface, respectively.

### The Second Embodiment

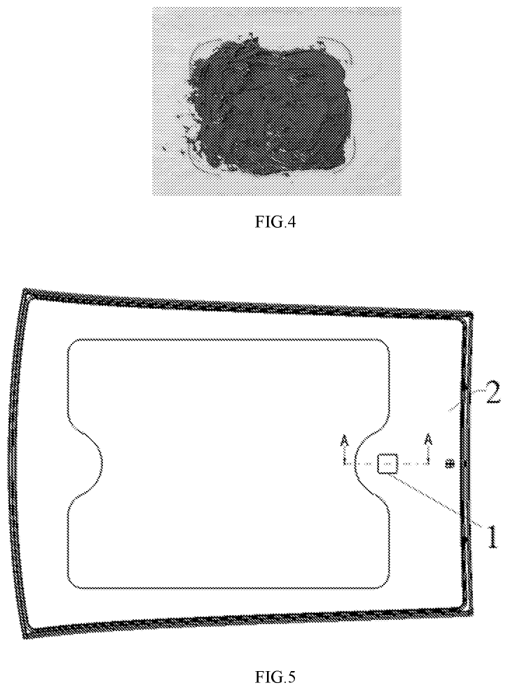

This embodiment provides a manufacturing method for a vehicle glass, including the following specific steps:
(1) applying a polyurethane adhesive to an edge area of each edge of a bottom surface of an antenna module to be bonded to glass by four-point spot coating, to form four adhesive blocks each in form of a line segment in the edge areas of all edges of the bottom surface, as shown in FIG. 3,
in this step, the antenna module has a weight of about 0.7 kg and a size of about 70×70 mm, and requires a tensile force of greater than 200 N, a width of the adhesive applied in step (1) is less than 8 mm, and a length of the adhesive applied is less than 25 mm;
(2) bonding the bottom surface of the antenna module to the glass by an adhesive layer formed by the adhesive to obtain the vehicle glass; the vehicle glass includes the glass, the adhesive layer and the antenna module, the antenna module is bonded to the glass by the adhesive layer, the adhesive layer includes four adhesive blocks each in the form of a line segment, and the four adhesive blocks are distributed on the edge areas of all edges of the bottom surface.

### The First Comparative Example

This comparative example provides a manufacturing method of vehicle glass, including the following specific steps:
(1) applying an adhesive to a bottom surface of an antenna module to be bonded to glass by full adhesive coating, as shown in FIG. 4,
in this step, the antenna module has a weight of about 0.7 kg and a size of about 70×70 mm, and requires a tensile force of greater than 200 N, and both a width and a length of the adhesive applied in step (1) is 70 mm;
(2) bonding the bottom surface of the antenna module to the glass by an adhesive layer formed by the adhesive to obtain the vehicle glass, the vehicle glass including the glass, the adhesive layer and the antenna module, and the antenna module being bonded to the glass by the adhesive layer.

### The First Test Example

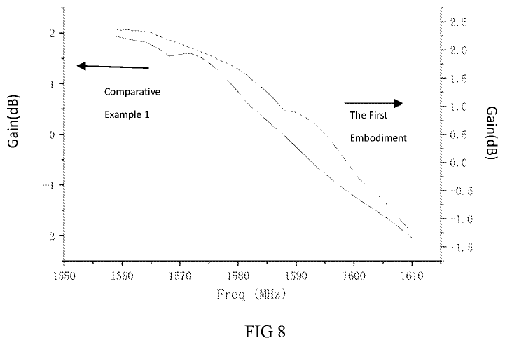

This test example adopts conventional methods currently existing in this field to test the Gain performance of the antenna modules in the vehicle glasses according to the first embodiment of the present disclosure and the first comparative example within the frequency range of 1160 MHz-1610 MHz, and the test results are shown in FIG. 7 and FIG. 8.

As is evident from FIG. 7 and FIG. 8, compared with the way to bond the antenna module to the glass by full adhesive coating in the first comparative example, the first embodiment of the present disclosure changes the way to coat the adhesive, that is, the first embodiment adopts four-point spot coating to bond the antenna module to the glass, and the Gain of the antenna module in the obtained vehicle glass within the frequency range of 1160 MHz-1610 MHz is significantly increased, with a maximum increase of about 1.5 dB.

### The Second Test Example

This test example tests the bonding strength between the antenna modules and the glasses in the vehicle-glass according to the first and second embodiments of the present disclosure and the first comparative example. This test was done using conventional tension meters that are currently available. Each piece of vehicle glass was tested twice. The test environment conditions were: temperature 22.6° C., humidity 58.3% RH.

The bonding strength data obtained in this test example are shown in Table 1 below.

TABLE 1

| | Bonding | Qualified |
|---|---|---|
| | strength/N | or not |
| The First Embodiment | 233.1 | Qualified |
| The First Embodiment | 236.6 | Qualified |
| The Second Embodiment | 239.5 | Qualified |
| The Second Embodiment | 241.9 | Qualified |
| The First Comparative | 246.8 | Qualified |
| Example | | |
| The Second Comparative | 244.6 | Qualified |
| Example | | |

From the experimental data in Table 1, it can be seen that the bonding strength between the antenna module and the glass in the vehicle glass provided in each of the first and second embodiments and the first comparative example is greater than 200 N, which indicates that, compared with the way to obtain vehicle glass by bonding the antenna module to the glass by full adhesive coating in the prior art, although the embodiments of the present disclosure adopt the four-point spot coating to bond the antenna module to the glass, the bonding strength between the antenna module and the glass still meets the requirement.

In conclusion, compared with the way to obtain vehicle glass by bonding the antenna module to the glass by full adhesive coating in the prior art, the present disclosure changes the adhesive application manner, that is, the present disclosure adopts the four-point spot coating to bond the antenna module or the bracket to the glass, and within a certain frequency range, the Gain of the antenna module in the vehicle glass obtained in the embodiments of the present disclosure is significantly increased; and, it can still be ensured that the bonding strength is greater than 200 N.

The above are only specific examples of the present disclosure, and cannot be used to limit the scope of implementation of the present disclosure. Thus, the replacement of equivalent components, or the equivalent changes and modifications made in accordance with the scope of patent protection of the present disclosure should still belong to the scope covered by this patent. In addition, the technical features of the present disclosure, the technical features and the technical inventions of the present disclosure, and the technical inventions of the present disclosure can all be freely combined and used

1. A vehicle glass, comprising a glass, an adhesive layer and an antenna module, wherein the antenna module is bonded to the glass by the adhesive layer, or the vehicle glass further comprises a bracket that is bonded to the glass by the adhesive layer and the antenna module is clamped on the bracket;
wherein the adhesive layer is distributed, in form of short lines, on an edge area of a bottom surface of the antenna module or an edge area of a bottom surface of the bracket.

2. The vehicle glass according to claim 1, wherein the short lines comprise line segments or short arcs.

3. The vehicle glass according to claim 1, wherein the adhesive layer is distributed on a periphery of the bottom surface of the antenna module or a periphery of the bottom surface of the bracket.

4. The vehicle glass according to claim 3, wherein the adhesive layer comprises four adhesive blocks each in form of a line segment, and the four adhesive blocks are distributed on the edge areas of all edges of the bottom surface.

5. The vehicle glass according to claim 4, wherein a length of the adhesive block is smaller than an edge length of the bottom surface.

6. The vehicle glass according to claim 5, wherein a length of the adhesive block is less than or equal to 40% of the edge length and is greater than or equal to 30% of the edge length, and a width of the adhesive block is not greater than 15 mm.

7. The vehicle glass according to claim 3, wherein the adhesive layer comprises four adhesive blocks each in form of a right-angled broken line structure, the four adhesive blocks are distributed on the edge areas of four corners of the bottom surface, and any two of the adhesive blocks do not completely connected.

8. The vehicle glass according to claim 7, wherein a total length of the four adhesive blocks each in the form of a right-angled broken line structure is not less than 30% of a total perimeter of the bottom surface and not greater than 40% of the total perimeter of the bottom surface, and a width thereof is not greater than 15 mm.

9. The vehicle glass according to claim 3, wherein the adhesive layer comprises four adhesive blocks each in form of a 90° round-corner broken line structure, and the four adhesive blocks are distributed on the edge areas of four corners of the bottom surface.

10. The vehicle glass according to claim 9, wherein a total length of the four adhesive blocks each in the form of a 90° round-corner broken line structure is not less than 30% of a total perimeter of the bottom surface and not greater than 40% of the total perimeter of the bottom surface, and a width thereof is not more than 15 mm.

11. The vehicle glass according to claim 1, wherein an adhesive for forming the adhesive layer comprises one or more selected from polyurethane, acrylic resin, polycarbonate resin, ABS resin, and fluororesin.

12. A manufacturing method for a vehicle glass, wherein comprising:
applying an adhesive to an edge area of a bottom surface of an antenna module or an edge area of a bracket by spot coating;
bonding the bottom surface of the antenna module to the glass to obtain the vehicle glass; or bonding the bottom surface of the bracket to the glass and then clamping the antenna module on the bracket to obtain the vehicle glass;
wherein the vehicle glass comprises a glass, an adhesive layer and an antenna module, wherein the antenna module is bonded to the glass by the adhesive layer, or the vehicle glass further comprises a bracket that is bonded to the glass by the adhesive layer and the antenna module is clamped on the bracket; and
wherein the adhesive layer is distributed, in form of short lines, on an edge area of a bottom surface of the antenna module or an edge area of a bottom surface of the bracket.

13. The manufacturing method according to claim 12, wherein the spot coating is multi-spot coating.

14. An intelligent connected vehicle, comprising a vehicle glass, wherein the vehicle glass comprises a glass, an adhesive layer and an antenna module, wherein the antenna module is bonded to the glass by the adhesive layer, or the vehicle glass further comprises a bracket that is bonded to the glass by the adhesive layer and the antenna module is clamped on the bracket; and
wherein the adhesive layer is distributed, in form of short lines, on an edge area of a bottom surface of the antenna module or an edge area of a bottom surface of the bracket.

15. The manufacturing method according to claim 12, wherein the short lines comprise line segments or short arcs.

16. The manufacturing method according to claim 12, wherein the adhesive layer is distributed on a periphery of the bottom surface of the antenna module or a periphery of the bottom surface of the bracket.

17. The manufacturing method according to claim 16, wherein the adhesive layer comprises four adhesive blocks each in form of a line segment, and the four adhesive blocks are distributed on the edge areas of all edges of the bottom surface.

18. The intelligent connected vehicle according to claim 14, wherein the short lines comprise line segments or short arcs.

19. The intelligent connected vehicle according to claim 14, wherein the adhesive layer is distributed on a periphery of the bottom surface of the antenna module or a periphery of the bottom surface of the bracket.

20. The intelligent connected vehicle according to claim 19, wherein the adhesive layer comprises four adhesive blocks each in form of a line segment, and the four adhesive blocks are distributed on the edge areas of all edges of the bottom surface.
